(19) United States
(12) Patent Application Publication
(10) Pub. No.: US 2003/0111238 A1
(43) Pub. Date: Jun. 19, 2003

(54) Flame arresting blankets on gas turbine

(76) Inventor: Stephen Arthur Anderson, Verdun (CA)

Correspondence Address: Gregory P. LaPointe, BACHMAN & LaPOINTE, P.C., Suite 1201, 900 Chapel Street, New Haven, CT, 06510-2802, US

(21) Appl. No.: 10/016,870

(22) Filed: Dec. 14, 2001

(51) Int. Cl. A62C 2/00

(52) U.S. Cl. 169/54

(57) ABSTRACT

A fire retarding device for covering a hot casing is disclosed. The device includes a member adapted to cover at least a portion of the hot casing and consists at least in part of a porous flame arresting matrix having a plurality of substantially interconnected voids defined therein. The voids have a maximum size which is predetermined to limit flame propagation of an ignited fluid across said voids. One possible construction for the matrix is one or more intermingled metal filaments arranged in a blanket-like form.

### TECHNICAL FIELD

The present invention relates to flame retarding blankets, and more particularly to a flame arresting blanket for the exterior surface of an aircraft engine.

### BACKGROUND OF THE INVENTION

Regardless of all precautions taken by a manufacturer of an aircraft or of an aircraft engine, and of those taken by an operator of the aircraft during its use, fire hazards resulting from the leakage of jet fuel are nevertheless an occasional possibility. If such a situation should occur in close vicinity to an engine in operation, the high temperatures of the engine casing significantly increase the chance of a resulting fire. Therefore means must be provided to minimize the risk of fire and reduce the possibility of fire propagation.

As such, many gas turbine engines use thermal blankets to shroud the “hot end” of the engine, the portion that experiences the highest temperatures downstream of the combustion chamber. The thermal blankets are most commonly composed of high temperature insulating materials wrapped in a thin sheet metal skin which provides insulation retention and structural rigidity. Thermal blankets reduce the temperatures of the exposed exterior surfaces of the engine casing to an extent necessary to reduce the risk of ignition of any leaked flammable fluid which comes into contact with the engine surfaces.

A major problem currently associated with traditional thermal blankets is their lack of flexibility. This results in significant difficulty in conforming the thermal blanket to, and installing it on, the often uneven exterior surface of the engine.

Some attempts have been made to address this issue. U.S. Pat. No. 5,976,997 issued Nov. 2, 1999 to Meaney et al, for example, discloses a lightweight fire protection arrangement for an aircraft gas turbine jet engine comprising a lightweight composite layer applied directly to the exterior surfaces of the engine to provide fire protection. The application of the composite layer is complex and permanent. Removal of this fire protection arrangement is impossible and significantly reduces access to the engine case, should this be required for maintenance purposes.

Flame retarding devices for a variety of other applications are well known. Flame arresting devices, for example, are often located in gas lines and pipes to prevent a flame from propagating along the entire length of the pipeline. In this context, mesh screens are placed across the pipe to retard a flame and prevent its propagation through the pipe. The mesh is sized to interfere with the minimum space required for a flame to propagate. Hence, the gas may pass through but the flame may not.

Thus, while attempts have been made to provide improved flame retarding thermal blankets which are lightweight and more easily conformable to the shapes of the exterior casing of the engine, a need for a simpler and more effective solution remains, and especially one which is easier to install and is removable for repair and overhaul purposes.

### SUMMARY OF THE INVENTION

It is an object of the present invention to provide an improved fire retarding device for hot equipment, such as an aircraft engine.

It is yet another object of the present invention to provide an improved lightweight fire retarding blanket.

It is a further object of the present invention to provide a fire retarding blanket that is more flexible such that it more easily conforms to and installs on an engine casing.

Therefore, in accordance with the present invention, there is provided a fire retarding device for covering a hot casing, comprising: a flexible member adapted for superposition on the hot casing, said member covering at least a portion of the hot casing; said member comprising a plurality of intermingled filaments forming a porous flame arresting fibrous network; said fibrous network having a volume being more porous than dense; and said filaments arranged to define voids of a maximum size throughout said fibrous network, whereby flame propagation of an ignited fluid is limited.

In accordance with another embodiment of the present invention, there is also provided a fire retarding device for removably covering a hot casing, comprising: a blanket adapted for immediate superposition on a hot casing, said blanket circumferentially covering at least a portion of said casing; said blanket comprising a plurality of filaments engaged to form a flame arresting mesh matrix; said mesh matrix, having a top mesh surface and a bottom mesh surface, comprising superimposed layers formed of a plurality of said filaments in intersecting engagement and a plurality of said filaments extending between said top and bottom mesh surfaces; and said filaments defining voids of a maximum size throughout said mesh matrix, whereby said voids define a mesh size predetermined to limit flame propagation of an ignited fluid.

There is additionally provided a fire retarding device for superposition on a hot casing, comprising: a member adapted to cover at least a portion of the hot casing; said member comprising a porous flame arresting network having a plurality of fibrous elements defining interconnected voids extending throughout said network; said flame arresting network defining a volume being more porous than dense, and said voids having a maximum size; whereby said maximum size of said voids limits flame propagation of an ignited fluid through said member.

Filaments and fibres as described herein can be any elongated, substantially malleable member having any constant or varying transverse cross-sectional shape, such as rectangular, square, circular, or any other irregular shape including those with high surface areas. Each filament can additionally be comprised of several individual strands, twisted, plaited or otherwise combined together to form a single filament. A mesh, a described herein, can be any regular or irregular intertwined combination of the filaments and fibres to form a porous solid material. Such a network of fibrous elements can therefore be analogous in structure to an ordered lattice material, or a disordered material similar to wire wool.

### BRIEF DESCRIPTION OF THE DRAWINGS

Further features and advantages of the present invention will become apparent from the following detailed description, taken in combination with the appended drawings, in which:

FIG. 1 is a schematic side view of a gas turbine engine having a flame arresting blanket according to the present invention.

FIG. 2 is a schematic cross-sectional view taken along line 2-2 of FIG. 1.

FIG. 2a is a schematic detail view of section 2a of FIG. 2.

FIG. 3 is a schematic cross-sectional view taken along line 3-3 of FIG. 2.

FIG. 4 is a schematic cross-sectional view similar to FIG. 2 of an alternate embodiment of the present invention.

FIG. 5 is a schematic cross-sectional view taken along line 5-5 of FIG. 4.

### DETAILED DESCRIPTION OF THE PREFERRED EMBODIMENT

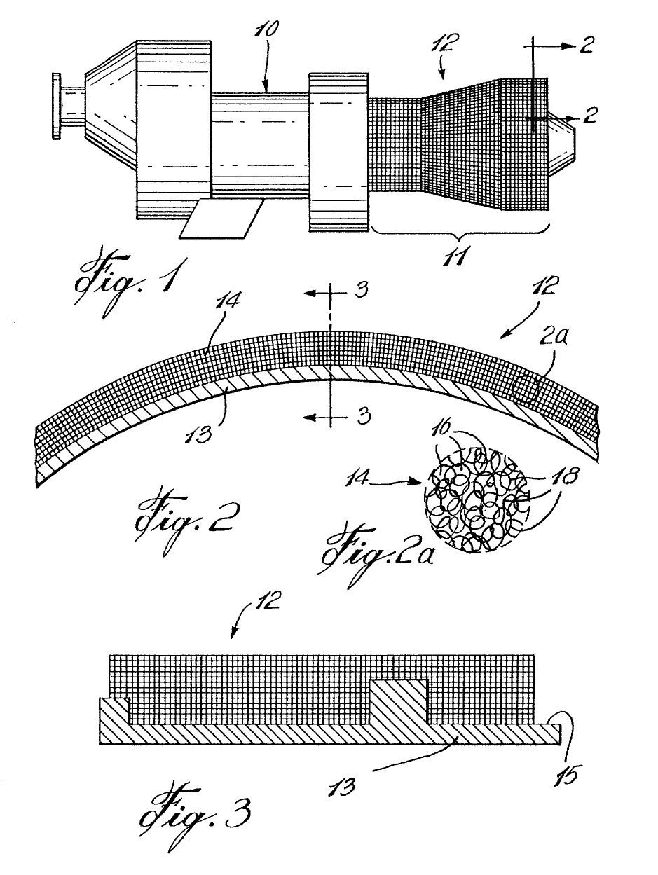

While the present invention has application to any hot equipment with which there is a risk of fire caused by flammable liquids coming in contact therewith, the present invention will be described herein in context of its application to an aircraft gas turbine engine. Referring to FIG. 1, an aircraft gas turbine engine 10 has a rear “hot end” section 11, located generally downstream of the combustion chamber of the engine. The engine components in this area are exposed to the highest temperatures, and consequently this becomes the hottest part of the exterior engine casing. In the event of a flammable fluid leak, such as a jet fuel leak for example, exposure of the fluid to high temperatures, such as would occur with direct contact of the fluid with hot engine casing, may result in ignition of the flammable fluid and thus poses a danger.

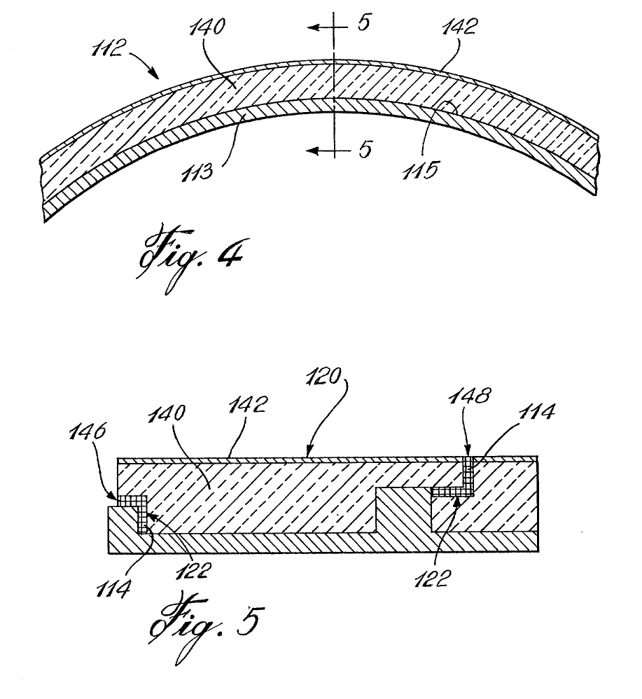

Referring FIGS. 2, 2a and 3, in accordance with the present invention, a flame arresting blanket 12, is disposed about an engine casing 13. As discussed further below, the flexibility of the blanket generally permits it to conform relatively easily to the shape of the engine casing 13. The blanket preferably covers most or all of the engine casing 13, although in some applications it may be desirable to cover the engine casing partially.

In the preferred embodiment, the blanket 12 is comprised of a flame arresting “mesh” 14 composed of voids 16 defined between intertwined fibres or filaments 18. The size of the voids 16, i.e. the size of the voids between each wire filaments 18, referred to herein as the “mesh size”, is predetermined for the specific application as described further below. The mesh size is such that the gaps are no larger than a maximum distance permitted for preventing flame propagation for the specific flammable fluids used. This aspect of the invention will now be described in more detail.

It is known that flame fronts propagate outward from their ignition source. To propagate, however, a flame requires at least a certain amount of space to do so. If there is insufficient space adjacent the flame, the flame cannot propagate in that direction. The amount of space required depends on the flame characteristics, which is dependent in part on the fuel burned. Therefore, if the mesh size is correctly chosen for the pertinent flammable fluid, such that the gaps in the wire mesh are small enough, flame propagation can be prevented. Thus, the flame arresting blanket of the present invention does not prevent the flammable fluid from igniting, but does prevent the flame from propagating beyond the mesh.

As mentioned, flame arresting blanket 12 is made of a porous material having a multiplicity of voids defined therein, however none of the voids exceed the maximum gap for stifling flame propagation. The specific internal configuration of the fibrous network of flame arresting material is not necessarily critical, as long as the maximum air gap length is not exceeded along any path away from the engine towards the outer surface of the flame arresting blanket 12. Preferably the maximum air gap in the material is not exceeded in any direction (three-dimensionally speaking) within flame arresting blanket 12, although in light of the present disclosure one skilled in the art will appreciate that exceeding the maximum air gap in a purely circumferential or axial direction relative to the engine will permit flame propagation along the engine surface, or parallel to it, but not through the protective layer provided by flame arresting blanket 12 to its outer surface where harm could be caused. Rather, the flame would remain contained beneath flame arresting blanket 12. However, as mentioned, it is most preferable if flame propagation is not permitted in any direction. Preferably, the voids are also substantially interconnected so as to allow blanket 12 to be porous to a liquid such as jet fuel. The network of fibrous elements is necessarily more porous than dense, but is, as mentioned above, preferably at most about 10% dense.

The material of flame arresting blanket 12 must of course be resistant to the heat to which it is subjected adjacent the engine in operation, and should not itself be flammable. Preferably the properties of the material selected such as material type, thickness and porosity, should result in reduced transmission of heat to the outer layers of the blanket so that the outer layers are below the ignition temperature of the flammable liquids such as jet fuel against which protection is sought.

The fibrous network of mesh 14 is preferably a lightweight high temperature resistant wire mass, composed of stainless steel or a nickel alloy, for example. In the preferred embodiment, flame arresting blanket 12 is composed of a porous fibre metal material such as stainless steel or nickel FELTMETAL™ fibre metal (trade mark of Brunswick Corporation). Preferably, a fibre metal layer having a percent-density of less than 10% is used, to provide flame arresting blanket 12 with the beneficial reduced heat conductivity associated properties of a lower density material. However, as density decreases, one will appreciate that more care must be taken to ensure that the maximum air gap throughout the full depth of material layer is not exceeded.

Other materials could be used for the mesh 14, provided they have some structural integrity while remaining somewhat malleable to allow flexibility. Instead of metal, high temperature composites may be used. Instead of intertwined filaments, the mesh 14 may be comprised of a plurality of layers of perpendicularly overlapping wire filaments 18, which are arranged in a repeated pattern to create a mesh solid having a maximum mesh void size 16. The specific arrangement of the filaments 18 which comprise the mesh 14 is not that important, provided there a maximum mesh size is not exceeded anywhere throughout the material, as described above. Alternately, a foam-like cellular blanket may be provided, made up of thin radially upstanding ribbons, or other configuration, extending axially and circumferentially and intersecting to form grid elements, provided that voids are provided and do not exceed the predetermined maximum mesh void size throughout the blanket.

Therefore, while prior art thermal blankets use insulating materials to prevent fire by reducing the temperatures of the exposed surfaces to prevent ignition of any flammable fluid coming into contact therewith, the present invention effectively quenches an ignited flame by preventing propagation away from the engine casing. Any leaking fluid is still permitted to contact the hot engine case, however, any flame which results is retained adjacent the engine case and is not able to pass through the blanket 12 to the surrounding engine nacelle. This results in a significantly lighter weight fire arresting blanket, as the total volume of protective material around the engine is reduced. The prior art sheet metal skins and thermal blankets require fastening studs and various attachment flanges which significantly adversely affect the overall weight of the thermal blanket, These are not required with the present invention, and weight savings are accordingly made. The mesh blanket 12 can be laced together at the seams using thin wire filaments, eliminating much of the heavy attachment means required by thermal blankets. Other attachment means are also available.

The mesh flame arresting blanket is also preferably relatively easily conformed to the engine casing due to the flexibility of its preferred construction. The blanket of the present invention also provides much more malleability than the relatively stiffer sheet metal skin of the prior art thermal blanket, which permits a simpler installation process, saving both time and cost. Additionally, this flexibility makes it easier to ensure a good fit on the engine casing.

The present invention is furthermore preferably removable and replaceable. With relatively little difficulty, the fire arresting blanket 12 can be removed from the engine casing, as may be required for periodic regular engine maintenance for example. The present invention additionally permits a durable design relative to the temperamental sheet metal skins of the prior art, which are much more susceptible to incidental damage.

Referring to an alternate embodiment of the present invention in FIGS. 4 and 5, the fire retarding blanket 112 comprising thermal blanket sections 120 and flame arresting sections 122, includes a flame arresting wire mesh 114. This hybrid between traditional thermal blankets and the full wire mesh blanket 12 of the present invention, permits some of the advantages of the present invention to be achieved without having to replace an existing fire prevention arrangement. This allows retrofitting gas turbine thermal blankets currently in use, to provide better conformity to the engine case and simplified installation of the blanket on the engine.

The blanket 112 comprises high temperature insulating material 140, wrapped directly to the engine casing 113, and retained in place with a thin sheet metal covering skin 142. The exterior sheet metal shell 142 provides structural support for the sections of insulating material 140. In contrast to traditional thermal blankets, however, the blanket 112 additionally comprises flame arresting sections 122 made of a flame arresting wire mesh 114, similar in construction to the flame arresting wire mesh 14 described above. The flame arresting mesh sections 122 are preferably located at all external joints, including joints 146 between the blanket sections 120 and the engine casing surface 115, and joints 148 between adjacent blanket sections 120.

The mesh sections 122 provide an improved ability to conform the blanket to the shape of the engine, due to the flexibility of the mesh 114 at the points of contact with the engine casing 113, without requiring the replacement of the entire thermal blanket. Any gaps between the mesh sections 122 and the blanket sections 120, or between the mesh sections 122 and the engine case 113, should be no larger than the maximum gap size necessary to prevent flame propagation, as discussed above. Any leaking fluid that passes through joints between the thermal blanket sections 120 is not prevented from contacting the hot engine case under the blanket 112, but any flame the may result would be arrested under the blanket by the properties of the mesh 114 of the mesh sections 122, described above.

Much as traditionally used aircraft engine casing thermal blankets, the purpose of the present invention is to prevent or contain an external engine fire. However the means by which the present invention achieves this differs substantially. The insulative properties of thermal blankets cause the hot engine case to be cooled down to a temperature sufficiently low to make ignition of a spilled flammable fluid less likely. The flame arresting mesh blanket 12 of the present invention, being porous, does not prevent flammable fluid from coming in contact with the hot engine case, nor does it attempt to cool the casing down. Rather, the fine mesh of the flame arresting blanket 12 prevents an ignited flame from propagating, thus immediately tending to extinguish an ignited flammable fluid, thereby reducing the possibility of an external engine fire. Again, it will be understood that while the term “mesh” is used herein throughout the description, a net-like arrangement is not necessarily implied. The material and composition of the present invention has been fully described herein, and such description should be imported (in context, of course) wherever the term “mesh” is used.

The embodiments of the invention described above are intended to be exemplary only. For example, though described only in respect to a gas turbine engine, the present invention may be applied wherever a hot casing requires flame protection. The scope of the invention is therefore intended to be limited solely by the scope of the appended claims.

1. A fire retarding device for covering a hot casing, comprising:
a flexible member adapted for superposition on the hot casing, said member adapted to cover at least a portion of the hot casing, said member comprising intermingled filaments forming a porous flame arresting fibrous network; said fibrous network having a volume being more porous than dense, and wherein said filaments are arranged to define voids of a maximum size throughout said fibrous network, and wherein said maximum void size is chosen to limit flame propagation of an ignited fluid through said member.

2. The fire retarding device as defined in claim 1, wherein the fire retarding device is removable from said hot casing.

3. The fire retarding device as defined in claim 1, wherein said filaments are irregularly intertwined to form said fibrous network.

4. The fire retarding device as defined in claim 1, wherein said member is entirely comprised of said flame arresting fibrous network.

5. The fire retarding device as defined in claim 1, further comprising a plurality of insulative thermal blankets disposed adjacent one another around said hot casing, and wherein a said flexible member is disposed between adjacent sections of said insulative thermal blankets.

6. The fire retarding device as defined in claim 1, further comprising an insulative thermal blanket disposed around said hot casing, and wherein a said flexible member is disposed around said insulative thermal blanket.

7. The fire retarding device as defined in claim 1, wherein said member is disposed immediately adjacent said hot casing.

8. The fire retarding device as defined in claim 1, wherein said hot casing is an aircraft engine casing.

9. The fire retarding device as defined in claim 1, wherein said filaments are metal.

10. A fire retarding device for covering a hot casing, comprising:
a blanket said member adapted to cover at least a portion of the hot casing, said blanket comprising a plurality of filaments arranged to form a flame arresting matrix, said filaments intersecting in said matrix to form a plurality of voids in said matrix, said voids being smaller than a maximum size throughout said mesh matrix, said maximum size predetermined being to limit flame propagation of an ignited fluid across said voids.

11. The fire retarding device as defined in claim 10, wherein said blanket is disposed immediately adjacent said hot casing.

12. A fire retarding device for covering a hot casing, comprising:
a member adapted to cover at least a portion of the hot casing, said member comprising a porous flame arresting matrix having a plurality of substantially interconnected voids defined therein, said voids having a maximum size, said maximum size being predetermined to limit flame propagation of an ignited fluid across said voids.

13. The fire retarding device as defined in claim 12, wherein said member is disposed immediately adjacent on the hot casing.

14. The fire retarding device as defined in claim 12, further comprising at least one insulative thermal blanket.

15. The fire retarding device as defined in claim 12, wherein the hot casing is an aircraft jet engine casing and wherein said flammable fluid is jet fuel.

16. The fire retarding device as defined in claim 12, wherein said flame arresting matrix has a percent-density of between 10% and 30%.

17. The fire retarding device as defined in claim 12, wherein said voids do not exceed a maximum size in at least a direction extending substantially outwardly from said hot casing.

18. The fire retarding device as defined in claim 12, wherein said member is removable from said hot casing.

19. The fire retarding device as defined in claim 12, wherein said member is composed of a metal.
